(19) United States
(12) Patent Application Publication
(10) Pub. No.: US 2010/0325045 A1
(43) Pub. Date: Dec. 23, 2010

(54) JSI biometric payment system

(75) Inventor: Linsley Anthony Johnson, Berkeley, CA (US)

Correspondence Address: LINSLEY A. JOHNSON, 2214 CHANNING WAY # 8, BERKELEY, CA, 94704, US

(73) Assignee: LINSLEY ANTHONY JOHNSON, BERKELEY, CA (US)

(21) Appl. No.: 12/456,710

(22) Filed: Jun. 22, 2009

(51) Int. Cl. G06Q 40/00

(52) U.S. Cl. 705/44

(57) ABSTRACT

The JSI Biometric Payment System is designed to work in conjunction the JSI Key and its' Chip Recognition System. The JSI Biometric Payment System is designed for the point of sales and payment industries and their different markets, the banking and financial institutions, and ATM networks to eliminate fraudulent electronic business transactions and identity theft. The JSI Biometric Payment System can be scaled-up or downsized to be implement in different markets depending on their payment landscape. JSI Biometric Payment System can be used in a mobile and wireless application, multi- and single lane retail outlets, banking transactions internal and external (ATM) network services.

The JSI Biometric Payment System is designed to work in conjunction with the JSI Key and its' Chip Recognition System (Application # 11-900-118). The Biometric Payment System is designed for the point of sales and payment industries and their different markets, the banking and financial institutions, and ATM networks to eliminate fraudulent electronic business transactions and identity theft. The Biometric Payment System can be scaled-up or downsized to be implement in different markets depending on their payment landscape. The Biometric Payment applications are designed for mobile and wireless platforms, multi- and single lane retailers, banking transactions internal and external and (ATM) network services.

The Biometric Payment System is 6×8 in dimension with a biometric scanner integrated into the surface (top) of the system that is designed for identifying and reading the handprints and fingerprints that are stored on a JSI Key. The user of the JSI Key is required to insert his or her key into the biometric payment system and then place his or her hand or fingerprint on the scanner. The biometric scanner will compare the stored print on the JSI Key to the scanned print by the Biometric Payment system and if the print is a match the user financial data will appear on the screen for the owner to select the form of payment and if the print does not match no service will be provided.

The Biometric Payment System can read the credit card or merchant data off the JSI Key in a point of sales application and send and receive requested approvals for a point of sales transaction; send and receive data from ACH Automated Clearing Houses that authorize payments for point of sales transactions. The JSI Key and Biometric Payment System guarantees' the bank or financial institutions that this is not a fraudulent transaction.

The Biometric Payment System can read, identify and match the finger or hand print that is stored on a JSI Key when the JSI Key is inserted into the Biometric Payment System. This process and transaction is conducted in a real time environment and no data is stored in the Biometric Payment System all requests and approval are sent directly to designated bank, financial institution or clearing house.
1. Keyholder inserts JSI Key into the biometric scanner payment system reader.
2. Keyholder places their hand on top of biometric scanner payment scanner.
3. Handprint or fingerprint is scanned to match HP /FP stored on the JSI Key.
4. If the scanned HP/FP matches the stored HP/FP, Keyholder financial menu opens along with photo and other designated information.
5. Keyholder selects a form of payment or split payment among the financial applications stored on the JSI Key.
6. Transaction is completed, receipt generated for Keyholder.
7. If the scanned FP/HP does not a match the FP/HP stored on the JSI Key no financial information will be provided at the point of sales and the transaction can not be conducted.

### MANNER OF PROCESS OF MAKING

The JSI Biometric Payment System is made in the following steps
1. Sheets of Polyvinyl Chloride Acetated plastic that are molded in shape into a (6×8) dimension in parts A and B to be sealed together at the end of the production process.
2. Part (A) consists of an optical infrared LED biometric scanner.

### Part A: JSI Biometric Payment System:

(1). Integrated Infrared Biometric Handprint and Fingerprint Sensor and Scanner with (500 DPI) on a glass display.
(2) (1/4) VGA 320×240 pixel LCD with backlighting
(3) (15) lines×40 characters including graphics
(4) (3) inch insertion point on the right side of the JSI Payment product for the JSI Key to be inserted to connect to the internal USB port.
(5) (8) inch magnetic reader for gift cards and other low risk cards with no credit lines attach to them on the top of the JSI payment system for magnetic swiping purposes.
   Part (B) is the base of the unit that has the following items installed in the base of the unit.

### Base Terminal:

Processor: 68302 microprocessor

### Memory: 2 MB of FLASH and 1 MB of SRAM

### Internal USB Connector for JSI Key

JSI-Biometric reader and scanning software
Triple track (tracks 1, 2, 3), high coercivity, bi-directional

### Standard I/O Configurations

Physical Height: (6 in.); width: (8 in.); depth: (3 in.); weight: (2 lbs.)

### Security: DES, 3DES, RSA, Master/Session, DUKPT

### Programmable in ANSI C via the TXO Workbench

Supports Cables with Cable Sensing:
(a) 1 RS-485/RS-232 port and 2 RS-232 ports;
(b) 1 RS-485/RS-232 port, 1 LAN/RS-232 port, and 1 RS-232 port

### Enrollment Method: Single Finger, Multi-Touch Enrollment

### Extraction & Verification Time: ˜1 Second

### FRR: 0.0%-0.001% FAR: 0.01%-0.0001%

### Allowable Finger Rotation: +/−15° for 1:N; +/−180° for 1:1

### Image Data Compression: JPEG, Compression Ratio ˜8:1

### Environmental

0° to 40° C. (32° to 104° F.) operating temperature; 10% to 80% relative humidity, non-condensing
Power Requirements-120 VAC, 60 Hz; DC input 12 VDC, 1 Amp.

### Using the Same:

The JSI Biometric Point of Sales Application in theory is used in the same process as the present day point of sales. The core functions are the same, but the physical process are different based on the biometric technology. In the present market point of sales applications the credit card is swiped and the retailer may or may not ask for a supporting piece of identification. In the present point of sales environment there is a high number of fraudulent transactions, employee conspiracy, and identity theft, but the JSI Key can provides a 100% accurate identification at the point of sales application and reduce and eliminate fraudulent transactions and identity theft in a point of sales environment.

The JSI Key the JSI point sales application is designed to work in the retail, mobile and wireless applications.
1. Keyholder inserts JSI Key into the biometric scanner payment system reader.
2. Keyholder places their hand on top of biometric scanner payment scanner.
3. Handprint or fingerprint is scanned to match HP /FP stored on the JSI Key.
4. If the scanned HP/FP matches the stored HP/FP, Keyholder financial menu opens along with photo and other designated information.
5. Keyholder selects a form of payment or split payment among the financial applications stored on the JSI Key.
6. Transaction is completed, receipt generated for Keyholder.
7. If the scanned FP/HP does not a match the FP/HP stored on the JSI Key no financial information will be provided at the point of sales and the transaction can not be conducted.
   Title of invention

### JSI Biometric Payment System (BPS)

### CROSS-REFERENCE TO RELATED APPLICATION

1. JSI Key Application number -11-900-118.
2. JSI Biometric Point of Sales Application Application number -60-999-1117
3. JSI Biometric Automotive Application Application number-61-191-o41
4. JSI Biometric Residential and Facility Access Unit Application number 61-191-042

### STATEMENT REGARDING FEDERALLY SPONSORED RESEARCH OR DEVELOPMENT

No federally sponsored research is associated with this patent application.

### REFERENCE TO SEQUENCE LISTING, A TABLE OR A COMPUTER PROGRAM LISTING COMPACT DISC APPENDIX

Not applicable for this product

### BACKGROUND OF THE INVENTION

In the area of point of sales, electronic transactions processes and security using credit, debit and merchant cards; the JSI Biometric Payment System surpasses all the present market technology and product. Presently the credit card companies, merchants, and financial institutions are losing millions of dollars in electronic fraud and identity theft. The JSI Biometric Payment System working in conjunction with the JSI Key can eliminate fraudulent point of sales transaction and any losses a business may have related to it point of sales transactions.

Presently the point of sales, electronic payment, credit, debit, merchant card and the banking industry are expose to and experiencing massive financial losses due to present transaction process. The owners of this transaction process and the components in the process have not made any strategic or structural changes in the transaction process in 25 plus years. Several cosmetic changes were introduce to the transaction process such as photos on the credit cards, micro-chips in the cards and other insignificant changes that did not reduce or eliminate fraudulent transactions, but the JSI Biometric Payment System can reduce and eliminate fraudulent transactions.

After researching and analyzing the present point of sales market, the credit, debit and merchant card industry Jstone Industries developed the JSI Biometric Payment System that derived from present market point of sales products and applications, retailers and banks losses due to fraudulent credit and bank transactions. The JSI Biometric point of sales application is an integral part of the product line from Jstone Industries and it flagship product the JSI Key. Jstone Industries has conducted a series of internal and external research projects in the areas of consumer behavior with the integration of biometric technology and consumers transactions and response behaviors.

Based on our business and consumer research, and our product development strategy, JSI developed a multi-functional biometric based product-line to eliminate identity and electronic theft, automotive theft, and provide entry access to high valued asset. The JSI biometric payment system is designed for multiple types of retail outlet and it has mobile and wireless application.

### BRIEF SUMMARY OF THE INVENTION

The JSI Biometric point of sales application is an integral part of the product line from Jstone Industries and it flagship product the JSI Key. The JSI Biometric Payment System can restructured the point of sales process to eliminate fraudulent credit and bank card transactions and electronic and identity theft which both have a direct correlations the business cost and revenues.

### BRIEF DESCRIPTION OF THE SEVERAL VIEWS OF THE DRAWING

From a standing position looking down the JSI Biometric Payment System is 6×8 in dimension with a biometric scanner integrated into the surface (top) of the system that is designed for identifying and reading the handprints and fingerprints that are stored on a JSI Key.

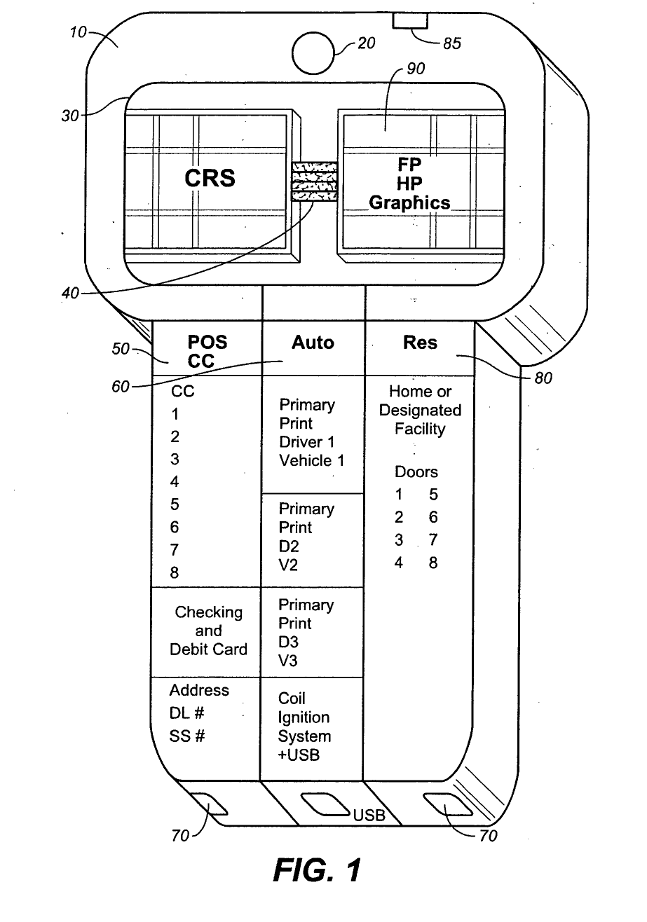

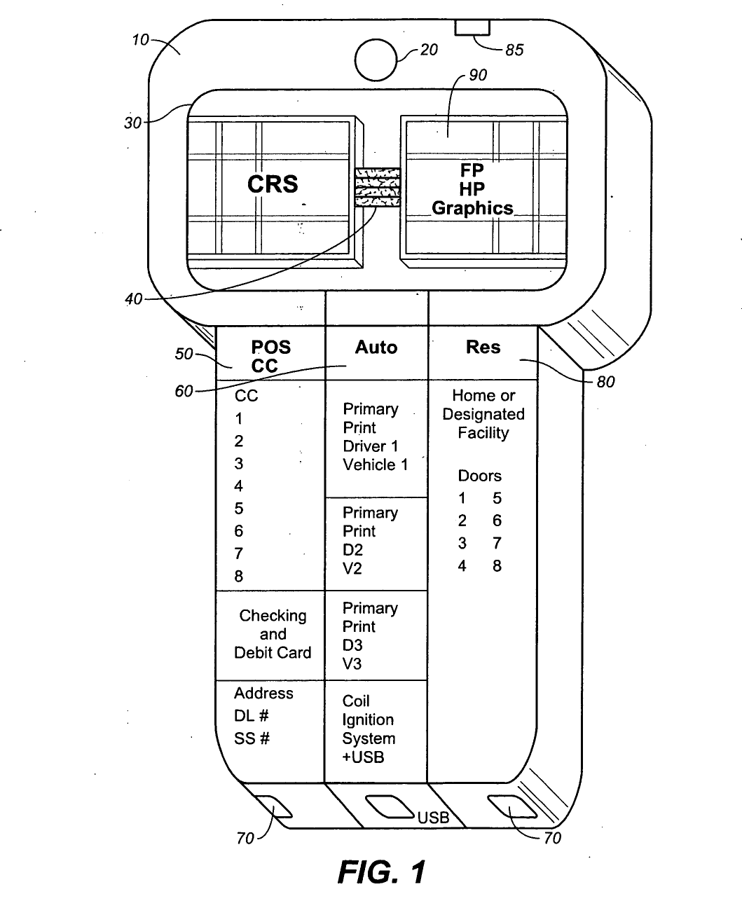

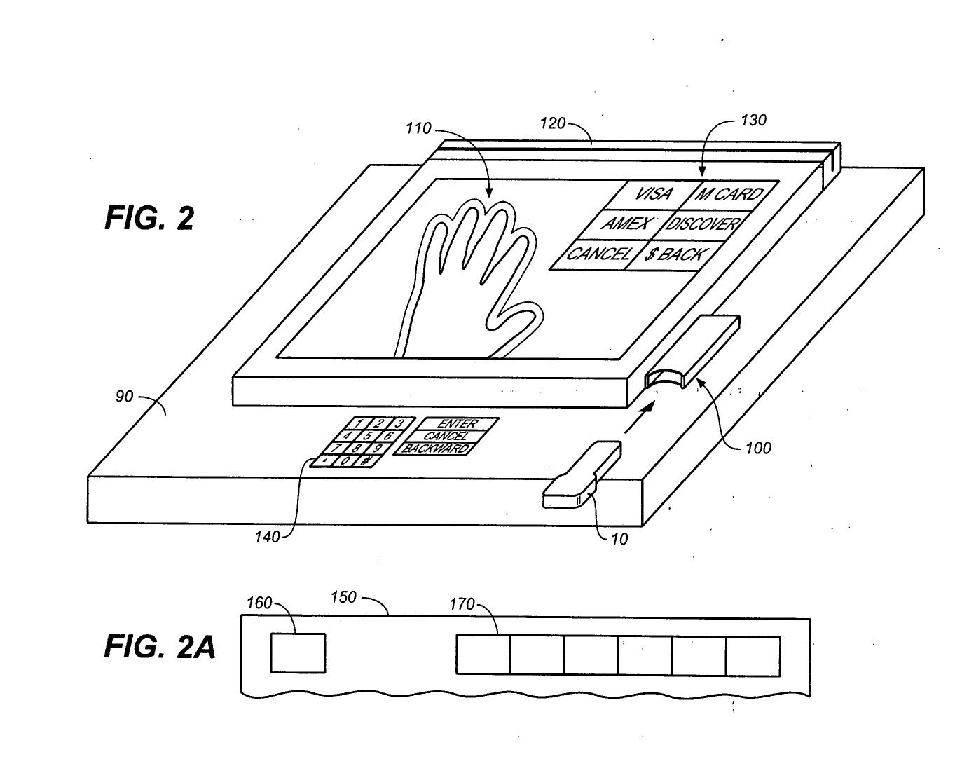

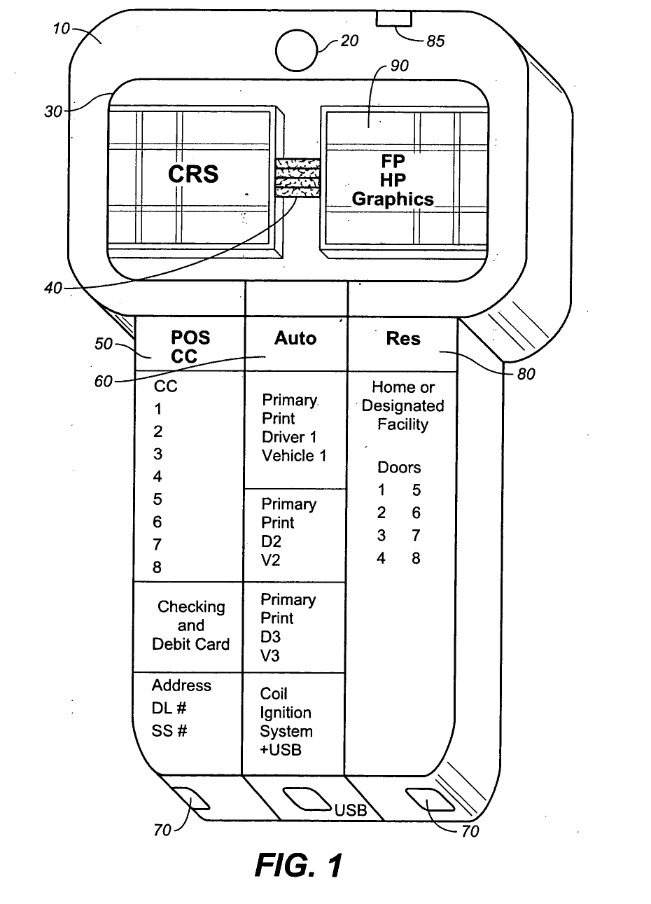

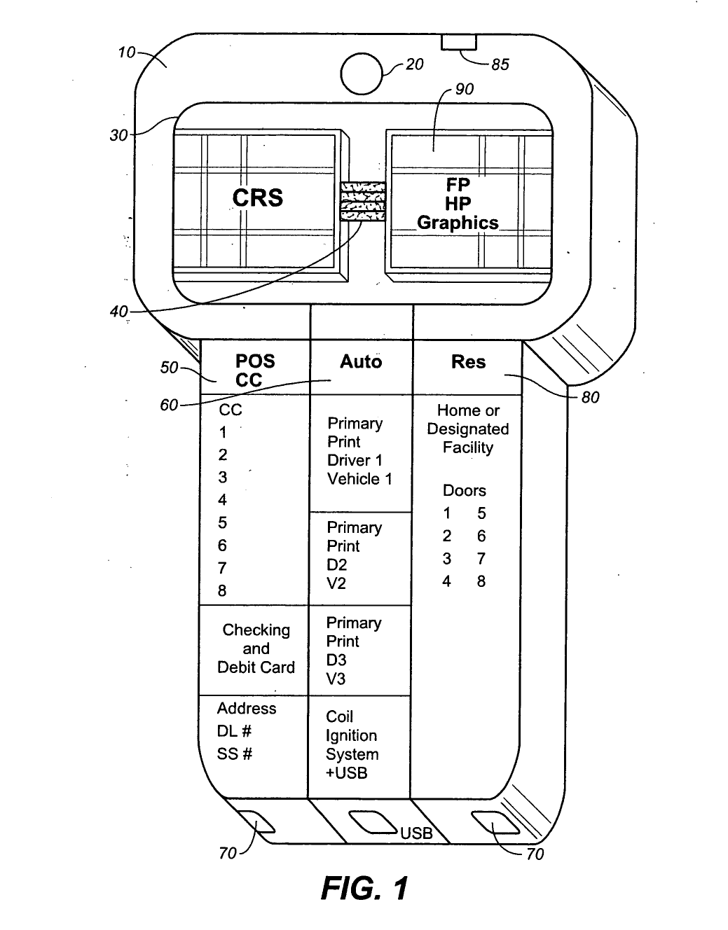

See FIG. 1 The JSI biometric key cross reference application number 11-900-118.

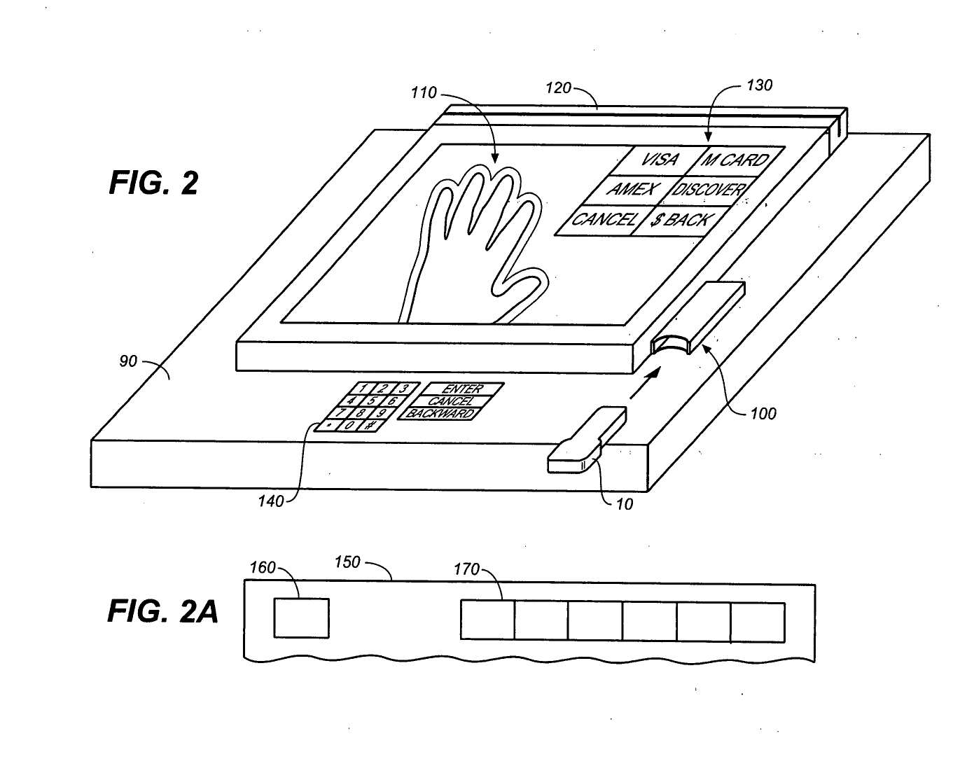

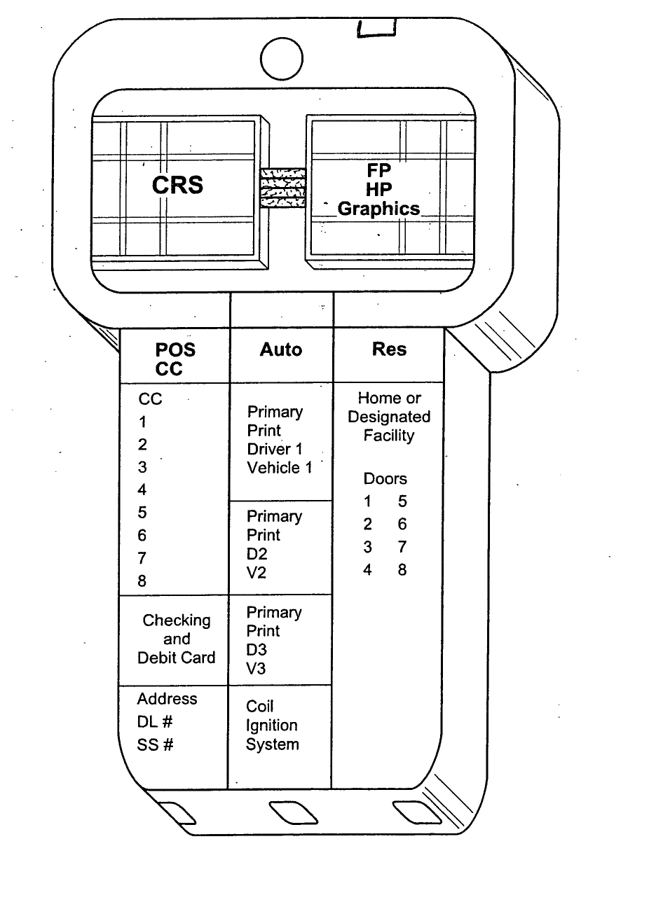

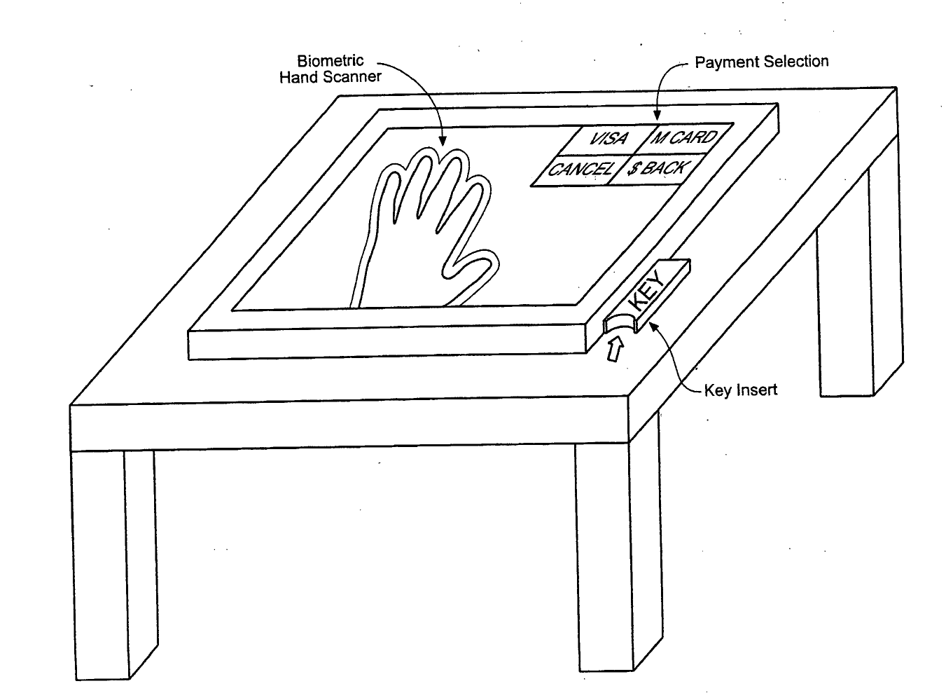

See FIGS. 2 and 2 A The JSI biometric payment system.

### DETAILED DESCRIPTION OF THE INVENTION

The JSI Biometric Payment System is a point of sales product that can scan, read, and match the biometric prints stored on a (JSI Key and its (CRS) Chip Recognition System Application # 11-900-118) in track (1) the point of sales application. After a JSI Key is inserted into a JSI Biometric Payment System the user will put his or her hand or designated finger on top of the scanner embedded in JSI Biometric Payment System. The scanner will do a search on the JSI Key track (1) for point of sales applications and search for matching print. If a matching print is located on the JSI Key the owner's financial information will appear on the screen and they can select the financial tool they want to use for payment at the point of sales out-let.

This product the JSI Biometric Payment System working in conjunction with the JSI Key functions totally different from the present market payment products and technology for authenticating a user identification and authorizing a designated user to use a credit or merchant card. The present market technology and process permit identity theft and major losses for merchants and banks. The JSI Key and the JSI Biometric Payment System will eliminate fraudulent credit or merchant card transactions.

The defining and strategic different in the JSI technology and present market products and technology is the process of identifying and authenticating the user to prevent fraudulent transactions. The JSI Biometric Payment System and the JSI Key is structurally and technically different due to biometric scanning technology installed in the JSI Biometric Payment System that required biometric match from the scanned print to the stored print on the JSI Key.

The JSI Biometric Payment System is made from similar market technologies and materials, but a strategic difference in the JSI payment product has an integrated biometric optical scanner for authenticating the authorized user, where the present market product does not require this technology, thus permitting electronic, identity and product theft from the merchant and card provider.

The JSI Biometric Payment System is made in the following steps
3. Sheets of Polyvinyl Chloride Acetated plastic that are molded in shape into a (6×8) dimension in parts A and B to be sealed together at the end of the production process.
4. Part (A) consists of an optical infrared LED biometric scanner.

### Part A: JSI Biometric Payment System:

(1). Integrated Infrared Biometric Handprint and Fingerprint Sensor and Scanner with (500 DPI) on a glass display.
(2) (1/4) VGA 320×240 pixel LCD with backlighting
(3) (15) lines×40 characters including graphics
(4) (5) inch insertion point on the right side of the JSI Payment product for the JSI Key to be inserted to connect to the internal USB port.
(5) (8) inch magnetic reader for gift cards and other low risk cards with no credit lines attach to them on the top of the JSI payment system for magnetic swiping purposes.
   Part (B) is the base of the unit that has the following items installed in the base of the unit.

### Base Terminal:

Processor: 68302 microprocessor

### Memory: 2 MB of FLASH and 1 MB of SRAM

Internal USB connector for the JSI Key.
JSI-Biometric reader and scanning software
Triple track (tracks 1, 2, 3), high coercivity, bi-directional

### Standard I/O Configurations

Physical Height: (6 in.); width: (8 in.); depth: (3 in.); weight: (2 lbs.)

### Security: DES, 3DES, RSA, Master/Session, DUKPT

### Programmable in ANSI C via the TXO Workbench

Supports Cables with Cable Sensing:
(a) 1 RS-485/RS-232 port and 2 RS-232 ports;
(b) 1 RS-485/RS-232 port, 1 LAN/RS-232 port, and 1 RS-232 port

### Enrollment Method Single Finger, Multi-Touch Enrollment

### Extraction & Verification Time: ˜1 Second

### FRR: 0.0%-0.001% FAR: 0.01%-0.0001%

### Image Data Compression: JPEG, Compression Ratio ˜8:1

### Environmental

0° to 40° C. (32° to 104° F.) operating temperature; 10% to 80% relative humidity, non-condensing
Power Requirements-120 VAC, 60 Hz; DC input 12 VDC, 1 Amp.

The JSI Biometric Payment System is used in the same capacity as other present market payment products, but there some strategic differences in the physical process and the final outcome of the transaction for the authorized user and the merchant who authorized credit on the JSI Key through the JSI Biometric Payment System.

In the present market point of sales applications the credit card is swiped and the retailer may or may not ask for a supporting piece of identification. In the present point of sales environment there is a high risk for fraudulent transactions but the JSI Key can provides a 100% accurate identification at the point of sales application and eliminate fraudulent transactions.

The JSI Biometric Payment System is designed to work in a point of sales application for retail merchants and can be scaled down for mobile and wireless product applications.
1. Keyholder inserts JSI Key into the biometric scanner payment system reader.
2. Keyholder places their hand on top of biometric scanner payment scanner.
3. Handprint or fingerprint is scanned to match HP /FP stored on the JSI Key.
4. If the scanned HP/FP matches the stored HP/FP, Keyholder financial menu opens along with photo and other designated information.
5. Keyholder selects a form of payment or split payment among the financial applications stored on the JSI Key.
6. Transaction is completed, receipt generated for Keyholder.
7. If the scanned FP/HP does not a match the FP/HP stored on the JSI Key no financial information will be provided at the point of sales and the transaction can not be conducted.

### DRAWING

### Formal Drawing

FIG. 1 The JSI Biometric Key Cross Reference Application Number 11-900-118

FIGS. 2 and 2 a The JSI Biometric Payment System

JSI-BIOMETRIC KEY & BIOMETRIC PAYMENT SYSTEM

| FIG. | |
|---|---|
| (1) | BIOMETRIC KEY |
| 10 | Biometric Key designed to prevent point of sales, vehicle |
| | thefts and provide entry access to high value assets or |
| | areas. Cross Reference Application 11-900-118 |
| 20 | Whole for carrying the biometric key on a key ring. |
| 30 | Chip Recognition System- System on a chip (CRS) |
| | designed to identify each landscape the biometric key can |
| | operate and provide access to; point of sales, automotive |
| | entry access. |
| 40 | Connectors that request, send and receive electrical signals |
| | to confirm and validate a stored finger print or hand print |
| | on a biometric chip or storage device. |
| 50 | Track (1) Point of sales: In this area the end user can store |
| | up to (8) credit or merchant card numbers, checking and |
| | debit card data, personal information, drivers' license, |
| | address. |
| 60 | Track (2) Vehicle/Auto: Provide up to (3) drivers secure |
| | biometric access to a vehicle to prevent theft. |
| 70 | USB connector to connect the biometric key to the |
| | designated landscape and provide the required data. |
| 80 | Track (3) Residential facility Access unit with up to |
| | (8) Biometric Identification Surface Pads. BISP. |
| 85 | Active light indicator to identify the key is properly |
| | working in each landscape; POS, AUTO, RESIDENTIAL. |
| 90 | Finger print/Hand Print chip for storing prints and |
| | verifying the designated owner. |
| | BIOMETRIC PAYMENT SYSTEM |
| FIGS. | |
| (1)&(2) | |
| 90 | Biometric Payment System for point of sales landscape |
| 100 | Insertion point for the biometric key |
| 110 | Biometric Scanner to scan hand print or fingerprint |
| 120 | Magnetic card reader for gift cards or non-credit or credit |
| | line cards. |
| 130 | Payment selection icons based on payment cards stored on |
| | the biometric key. Visa, Master Card, Amex, and Discover |
| 140 | Number pad 1-9 and enter button, backward button, and |
| | cancel button. |
| FIG. | |
| (2) A | |
| 150 | Back panel |
| 160 | A/C Adapter for electrical power. |
| 170 | Serial ports for data transmission. |

JSI-BIOMETRIC KEY & BIOMETRIC PAYMENT SYSTEM

| FIG. | |
|---|---|
| (1) | BIOMETRIC KEY |
| 10 | Biometric Key designed to prevent point of sales, vehicle |
| | thefts and provide entry access to high value assets or |
| | areas. Cross Reference Application 11-900-118 |
| 20 | Whole for carrying the biometric key on a key ring. |
| 30 | Chip Recognition System- System on a chip (CRS) |
| | designed to identify each landscape the biometric key can |
| | operate and provide access to; point of sales, automotive |
| | entry access. |
| 40 | Connectors that request, send and receive electrical signals |
| | to confirm and validate a stored finger print or hand print |
| | on a biometric chip or storage device. |
| 50 | Track (1) Point of sales: In this area the end user can store |
| | up to (8) credit or merchant card numbers, checking and |
| | debit card data, personal information, drivers' license, |
| | address. |
| 60 | Track (2) Vehicle/Auto: Provide up to (3) drivers secure |
| | biometric access to a vehicle to prevent theft. |
| 70 | USB connector to connect the biometric key to the |
| | designated landscape and provide the required data. |
| 80 | Track (3) Residential facility Access unit with up to |
| | (8) Biometric Identification Surface Pads. BISP. |
| 85 | Active light indicator to identify the key is properly |
| | working in each landscape; POS, AUTO, RESIDENTIAL. |
| 90 | Finger print/Hand Print chip for storing prints and |
| | verifying the designated owner. |
| | BIOMETRIC PAYMENT SYSTEM |
| FIGS. | |
| (1)&(2) | |
| 90 | Biometric Payment System for point of sales landscape |
| 100 | Insertion point for the biometric key |
| 110 | Biometric Scanner to scan hand print or fingerprint |
| 120 | Magnetic card reader for gift cards or non-credit or credit |
| | line cards. |
| 130 | Payment selection icons based on payment cards stored on |
| | the biometric key. Visa, Master Card, Amex, and Discover |
| 140 | Number pad 1-9 and enter button, backward button, and |
| | cancel button. |
| FIG. | |
| (2) A | |
| 150 | Back panel |
| 160 | A/C Adapter for electrical power. |
| 170 | Serial ports for data transmission. |

1. The JSI Biometric Payment System can read and confirm the biometric fingerprint or handprint and read the financial data stored on a JSI Key. The JSI Biometric Payment System can give the confirmed owner options in the payment selection. Finally, the JSI Biometric Payment System can send data in a secure format to a designated credit card providers or clearing house billing platforms to confirm purchase and payment.
